(19) United States
(12) Patent Application Publication
(10) Pub. No.: US 2008/0222031 A1
(43) Pub. Date: Sep. 11, 2008

(54) Method and system for fee payment for automotive services

(76) Inventors: Amos Shattner, Herzlia (IL); Avish Jacob Weiner, Tel Aviv (IL); Shlomo Zytman, Ra'anana (IL)

Correspondence Address: Pearl Cohen Zedek Latzer, LLP, 1500 Broadway, 12th Floor, New York, NY, 10036, US

(21) Appl. No.: 12/068,023

(22) Filed: Jan. 31, 2008

Related U.S. Application Data
(60) Provisional application No. 60/898,704, filed on Feb. 1, 2007.

(51) Int. Cl. G06Q 40/00

(52) U.S. Cl. 705/39

(57) ABSTRACT

The present invention provides a system and method for fee payment for automotive facilities, the system comprising: a facility gate unit having a user interface enabling a user to enter a user code, the facility gate unit enables entrance of the user to a respective automotive facility after entering the code; and a transaction server to receive from the facility gate unit the code entered by a user and to produce instruction to debit the user for the respective automotive facility service fee based on user identification, the transaction server is further to receive at least one payment instruction, and to provide confirmation that the fee was fully paid, wherein the facility gate unit enables exit from the respective facility after receiving the confirmation.

### CROSS-REFERENCE TO RELATED APPLICATIONS

This application claims the benefit of U.S. Provisional Patent Application No. 60/898,704, filed on Feb. 1, 2007, which is incorporated in its entirety herein by reference.

### BACKGROUND OF THE INVENTION

Known fee payment systems for automotive facilities or services such as parking lots and toll roads include identification of the client or the client's car and direct debit of the client by means of payment machines, seasonal subscriptions or through various communication systems that identify the client, for example, by a ticket with personal code, license plate number, credit card details, RFID, cellular phone number or subscription code.

Under such systems, if a third party, e.g., a party other than the client or the owner/operator of the automotive facility, wishes to pay the fee for the client for such automotive services, for example, as part of a sale or marketing campaign, the third party may stamp, mark or place a barcode sticker on the client's parking ticket or replace it entirely, and the client may provide this note or marked parking ticket to the fee receiving system or person. Such a system has drawbacks, for example, if the fee payment method is by means of automatic identification and debit, the fee payment by a third party may be impossible.

Therefore, there is a need for an improved system enabling automatic payment of a fee for automotive services by a third party.

### SUMMARY OF THE INVENTION

Embodiments of the present invention may provide a method and system for fee payment for automotive services by a party other than the receiver and the provider of such automotive services. The system may include a transaction server, at least one automotive facility and at least one automotive facility operator, at least one gate unit that controls fee payment for use of the automotive facility, and at least one third party, which may be any business center, for example, one proximate to an automotive facility, e.g., a restaurant, store, shopping center, entertainment center, theater, amusement park, or any other business.

In some embodiments, the transaction server may receive identification details of a client, a third party, and a facility operator, and send to the facility operator instructions to debit the third party for a use by the client of an automotive facility. The facility operator may notify the gate unit that the fee has been paid. Various embodiments are possible as described below, for example, the use credited may be a current use or a future use. The automotive service may be one proximate to the third party or to a related business center belonging to the same chain or/and to the same owner.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a system for fee payment for automotive services according to some embodiments of the present invention;

FIG. 2 is a schematic illustration of a system for fee payment for automotive services according to some embodiments of the present invention;

FIG. 3 is a flowchart illustrating a method for fee payment for automotive services according to some embodiments of the present invention;

FIG. 4 is a flowchart illustrating a method for fee payment for automotive services according to some embodiments of the present invention;

FIG. 5 is a flowchart illustrating a method for fee payment for automotive services according to some embodiments of the present invention;

FIGS. 6A, 6B and 6C are a schematic illustration of a system and optional parts thereof for fee payment for automotive services according to some embodiments of the present invention;

FIG. 7 is a flowchart illustrating a method for doing business according to an exemplary embodiment of the present invention; and

FIG. 8 is a flowchart illustrating a method for doing business according to an exemplary embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

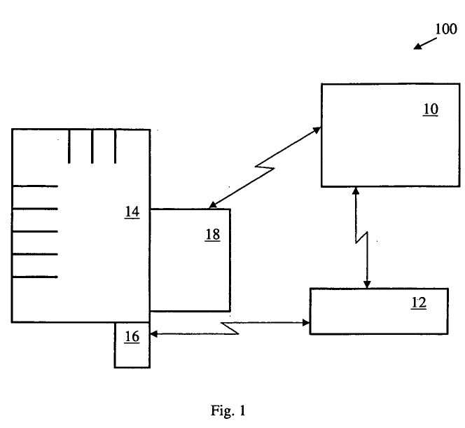

Reference is made to FIG. 1, which is a schematic illustration of a system 100 for fee payment for automotive services according to some embodiments of the present invention. System 100 may include transaction server 10, facility operator 12, automotive facility 14, gate unit 16, and third party 18. Third party 18 may be any business or entity, for example, one proximate to automotive facility 14, e.g., a restaurant, store, shopping center, entertainment center, theater, amusement park, or any other business or business center. A user, for example a client or potential client of third party 18 who enters automotive facility 14 with a car, may receive from gate unit 16 a ticket with personal code or may be otherwise identified by gate unit 16. Some examples of identification methods may be, for example, a license plate number, credit card details, RFID, cellular phone number, subscription code to the automotive facility or to the business center, or any other suitable identification method known in the art. Gate unit 16 may transmit a notice to facility operator 12 that the client has entered to automotive facility 14, thus creating a record of the client at facility operator 12. Then, facility operator 12 may transmit a notice to transaction server 10, including the identification of the client, in order, for example, that the transaction server will recognize the client and facility operator 12 upon receiving payment instructions. In other embodiments of the present invention, transaction server 10 may receive the identity of the automotive facility or the facility operator together with the payment instructions. In this case, there is no necessity for facility operator 12 to transmit a notice to transaction server 10 upon entrance of the client to automotive facility 14.

In some systems, clients may be registered to transaction server 10 for automatic payment for services, for example parking lots, toll roads or other automotive services. Some embodiments of the present invention may also be used for other services where the payment is based on an identification of the client. Registration to transaction server 10 may be performed, for example, by phone, by a registration form sent by mail, by on-line registration process or by any other suitable method. Registration to transaction server 10 may be performed, for example, at a point of sale at third party 18. Additionally, other servers to which a customer is registered may transmit the client's details to transaction server 10. Transaction server 10 may store, among other things, identification details and personal or marketing information of clients, facility operators and third parties. Transaction server 10 may receive from third party 18 payment instructions together with identification code of the registered client. The payment instructions may instruct full payment or partial payment for a facility usage session of the client. Transaction server 10 may recognize that the partial or full payment for the facility usage session of the identified client should be paid to facility operator 12, for example by matching the details of the registered client to the identification received by facility operator 12, or transaction server 10 may receive the identity of the automotive facility or the facility operator together with the payment instructions. Transaction server 10 may send instructions to facility operator 12 to partially or fully debit the client or third party 18 for the facility usage session of the client. Several partial payments from several third parties and/or clients according to embodiment of the present invention may accumulate until full payment for the facility usage session is achieved. In case the fee was fully paid, facility operator 12 may report to gate unit 16 that fee has been paid for a certain client. Gate unit 16 may control, for example, the automotive facility gate of automotive facility 14, and may allow exit and/or entrance to automotive facility 14 only after receiving a notice that the facility usage session of the client was paid for.

Third party 18 may offer to partially or fully pay the fee for usage of the automotive facility instead of its client, for example, with every purchase, or with purchases above a minimum amount, or at certain times of day or dates, or based on any other term or combination of terms it may choose. Third party 18 may also offer a partial or full credit to future use of an automotive facility, for example, the proximate automotive facility, or another automotive facility, for example, upon a sale or promotion by third party 18. In some embodiments of the present invention, the client is registered to transaction server 10, thus having an identification code stored in transaction server 10. When the identification code of a client is transmitted together with credit instructions to transaction server 10, for example, by third party 18, transaction server 10 may recognize the client and the facility operator. Therefore, transaction server 10 may send instructions to facility operator 12 to partially or fully debit third party 18 for a facility usage session of the identified client, for example, the last facility usage and/or a future facility usage.

In still other embodiments of the present invention, the client need not be registered to the transaction server 10 and thus there need not be any pre-stored identification code of the client in transaction server 10. In this case, third party 18 may transmit to transaction server 10, together with the partial or full payment or credit instructions, the identification of the client used by gate unit 16 when the client entered to automotive facility 14. Then, transaction server 10 may send this identification together with the instructions to facility operator 12 to partially or fully debit third party 18 for the facility usage session of the identified client.

An exemplary payment process by third party 18, according to some embodiments of the invention, may be payment by phone. Third party 18 may dial to transaction server 10 and may be identified by its phone number or a user code known in advance to the transaction server. Third party 18 may provide the transaction server with the client's identification used by gate unit 16 or the identification code of the client, in case the client is registered to transaction server 10. Transaction server 10 may recognize the client and send instructions to facility operator 12 to partially or fully debit third party 18 for the facility usage session of the identified client.

Another exemplary payment process by third party 18, according to some embodiments of the invention, may be payment by a network, for example, the internet. Third party 18 may access a port of transaction server 10, for example, via an internet server, and be recognize by a user code, for example, a user name and/or a password. Third party 18 may provide the transaction server, in the allocated web page, with the client's identification used by gate unit 16 or the identification code of the client, in case he is registered to transaction server 10. Transaction server 10 may recognize the client and send instructions to facility operator 12 to partially or fully debit third party 18 for the facility usage session of the identified client.

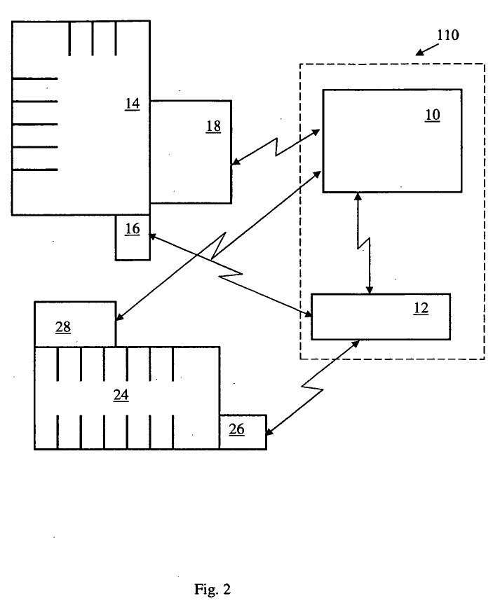

Reference is made to FIG. 2, which is a schematic illustration of a system 110 for fee payment for automotive services according to other embodiments of the present invention. System 110 may include transaction server 10, facility operator 12, automotive facility 14, having gate unit 16 and proximate third party 18, and automotive facility 24, having gate unit 26 and proximate third party 28. Facility operator 12 may operate several automotive facilities in different locations. Third parties 18 and 28 may communicate with transaction server 10 and gate units 16 and 26 may communicate with facility operator 12, as described above with reference to FIG. 1. Third parties 18 and 28 may partially or fully credit the customers for future use of either automotive facility 24 or automotive facility 14. Third parties 18 and 28 may be business related, for example, belong to the same chain or/and to the same owner. In order to encourage customers to come again to them or to other related business centers in the future, they may offer to partially or fully credit future use of automotive facilities proximate to any one of the related business centers, for example, upon future purchase in one of the business centers belong to the same chain or/and to the same owner. A system according to the present invention may include any number of automotive facilities, third parties and gate units and is not limited in this respect. In some embodiments, facility operator 12 and transaction server 10 may be included in the same unit.

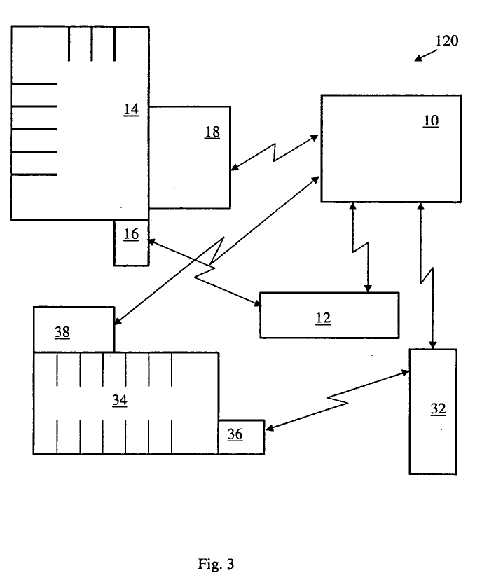

Reference is made to FIG. 3, which is a schematic illustration of a system 120 for fee payment for automotive services according to other embodiments of the present invention. System 120 may include transaction server 10, facility operators 12 and 32, automotive facility 14, having gate unit 16 and proximate third party 18, and automotive facility 34, having gate unit 36 and proximate third party 38. Automotive facility 14 and gate unit 16 may be operated by facility operator 12, and facility 34 and gate unit 36 may be operated by facility operator 32. Third parties 18 and 38 may communicate with transaction server 10 as described above with reference to FIGS. 1 and 2. Gate units 16 and 36 may communicate with facility operators 12 and 32, respectively, as described above with reference to FIGS. 1 and 2. For example, third party 18 may send credit instructions to transactions server 10 upon a first purchase by a client. The credit instructions may include an identification of the client and details regarding related business centers. Upon a second purchase by the client at third party 18 or at a related business center, e.g., third party 38, a notice may be sent to transactions server 10, which may send instructions to facility operator 12 or 32, respectively, to partially or fully debit, for example, the owner of third parties 18 and 38 for the facility fee.

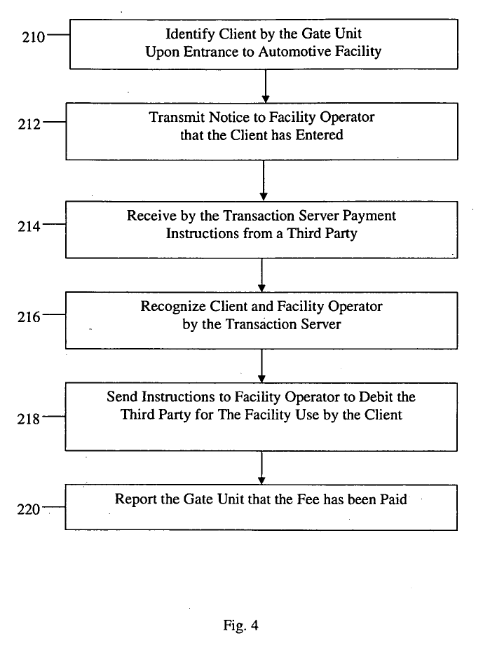

Reference is made to FIG. 4, which is a flowchart illustrating a method for fee payment for automotive services according to some embodiments of the present invention. As indicated in block 210, the method may include identifying the client by the gate unit upon entrance of the client to the automotive facility. As indicated in block 212, the method may include transmitting notice to the facility operator that the client has entered or accessed the automotive facility. As indicated in block 214, the method may include receiving by the transaction server payment instructions from a third party. In some embodiments of the present invention, the payment instructions may include the identification code of the client, if the client is registered to the transaction server. In other embodiments, the payment instructions may include the identification of the client used by the gate unit. As indicated in block 216, the method may include recognizing the client and the facility operator by the transaction server. The payment instructions may include the identity of the facility operator which should receive the payment, or the transaction server may automatically identify the facility operator based on the identity of the third party. As indicated in block 218, the method may include sending instructions to the facility operator to debit the third party for the facility use by the client. As indicated in block 220, the method may include reporting the gate unit that the fee has been paid.

It will be understood that third party may make full or partial payment for automotive services of the client, both in accordance with embodiments of the invention. Thus, in some embodiments of the invention, an amount paid by the third party may be communicated to the gate unit, and if the amount owed by the client for use of the automotive facility is greater than the credit or amount paid by the third party, the gate unit may demand and collect such remainder from the client.

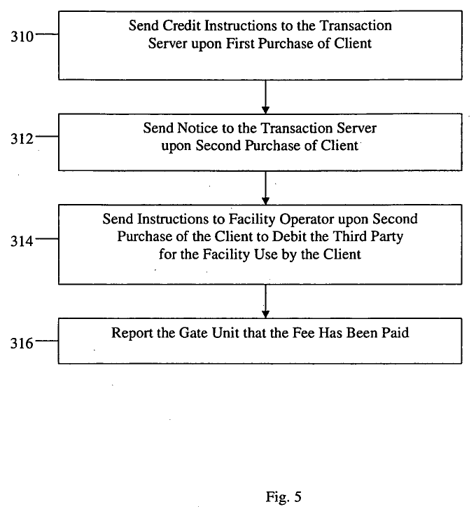

Reference is made to FIG. 5, which is a flowchart illustrating another method for fee payment for automotive services according to some embodiments of the present invention. As indicated in block 310, the method may include sending by a third party credit instruction to the transaction server upon first purchase of the client. The instructions may include a list of business centers related to the third party, wherein a purchase at one of these business centers or at the third party itself will credit the client for the use of the automotive service. As indicated in block 312, the method may include sending a notice to the transaction server upon a second purchase of the client. This second purchase may be at the third party or at one of a list of related businesses. As indicated in block 314, the method may include sending instructions to facility operator upon second purchase of the client to debit the third party for the facility use by the client. The facility operator may be the same operator of the facility proximate to the third party or any other facility operator connected to the transaction server, which operates a facility proximate to one of a list of related businesses. As indicated in block 316, the method may include reporting the gate unit that the fee has been paid.

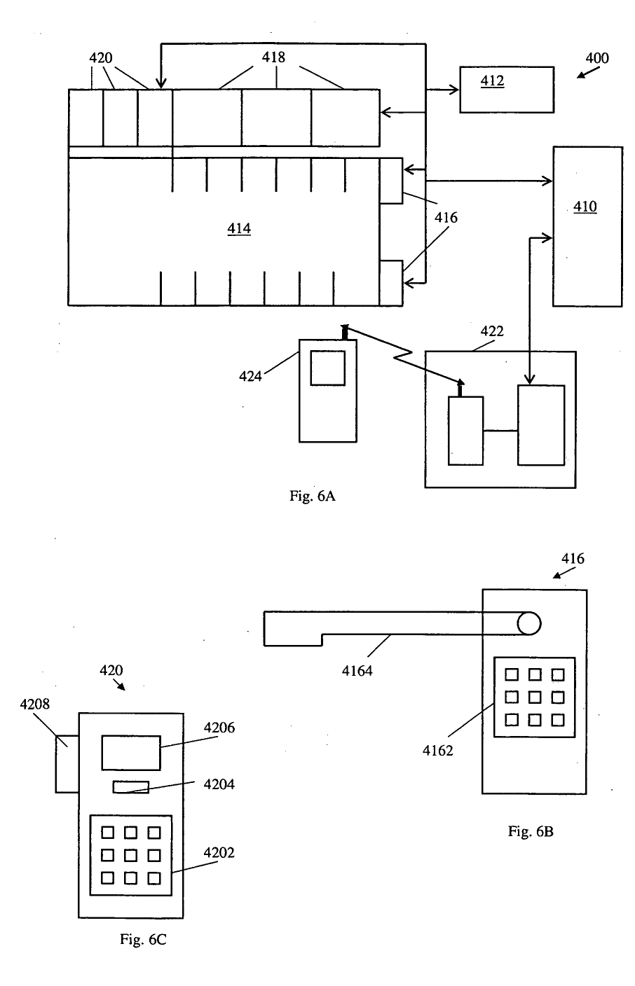

Reference is made to FIGS. 6A, 6B and 6C, which are schematic illustrations of a system 400 according to an exemplary embodiment of the present invention. FIGS. 6B and 6C are more detailed illustrations of alternative elements for gate unit 416 and payment machine 420, respectively, which may be alternately or additionally included in system 400 according to exemplary embodiments of the present invention. System 400 may include a transaction server 410, facility operator server 412, automotive facility 414, facility gate unit 416, third party units 418, payment machine units 420, network system 422 and mobile station 424. Transaction server 410, facility operator server 412 and facility gate unit 416 may communicate with each other directly or indirectly. Mobile station 424 may be able to communicate with Network system 422, e.g. receive and/or send transmissions from/to Network system 422. Network system 422 may be, for example, a cellular network system and mobile station 424 may be a cellular mobile station, e.g., a cellular mobile phone.

Gate unit 416 may include a user interface 4162, for example, a keyboard, and a gate 4164. In order to enter automotive facility 414, a user may enter a code which may identify the user with a mobile station, for example, a cellular phone. For example, the code may be the cellular phone number of the user. Additionally or alternatively, the code may enable identification of the user with a mobile station by, for example, at least one of gate unit 416, transaction server 410, facility operator server 412 and/or Network system 422, for example, by having a look-up table relating codes to mobile stations.

According to other embodiments of the present invention, a user may communicate with transaction server 410 before entering facility 414, by, for example, mobile station 424, for example, a cellular phone. In return, transaction server 410 may communicate to the user, for example, via mobile station 424, the entrance and/or the exit code which may be, for example, the same code, for example by an SMS message by network system 422. According to other embodiments of the present invention, a user may reserve a service of facility 414, for example, a parking space, in advance, by communicating with transaction server 410, for example, by mobile station 424, and perform a reservation. The reservation may include, for example, an indication of day, time and period for which a parking space is reserved by the user. In return, transaction server 410 may communicate to the user, for example, via mobile station 424, the entrance and/or the exit code, which may be, for example, the same code, for example by an SMS message by network system 422.

The code may be entered, for example, by keyboard 4162 and/or another user interface which may be included in facility gate unit 416. Unit 416 may verify that the entered code is a valid code. If the code should be a cellular phone number, unit 416 may verify that the entered code is a cellular phone number. The verification may be performed in gate unit 416 and/or in at least one of transaction server 410, facility operator server 412 and/or network system 422, which may receive the code from gate unit 416 and communicate to gate unit 416 the verification result. If the code is approved, gate unit 416 may allow entrance of the user to facility 414, for example, by opening gate 4164.

Gate unit 416 may communicate to transaction server 410 the entrance time of the user together with the code entered by the user and/or the identity of the mobile station and/or the cellular phone number identified with the user, if the identification of the user with a mobile station is done by gate unit 416. Gate unit 416 may communicate directly with transaction server 410 and/or the communication may be performed, for example, through operator server 412.

Transaction server 410 may send to network system 422 the identity of the mobile station and/or the cellular phone number identified with the user and/or the code entered by the user if the network system can identify the mobile station based on the code. Network system 422 may examine different parameters which may secure the transaction, for example, the validity of the identified mobile station, whether the identified mobile station has been reported stolen, the payments morality of the user and/or other suitable parameters which may be checked by, for example, the network operator.

Transaction server 410 may check whether the user is a subscribed user, for example, based on the code entered by the user and/or the identity of the mobile station and/or the cellular phone number identified with the user. If the user is identified as a subscribed user, transaction server 410 may communicate the exit code to the user, for example, via mobile station 424, for example by an SMS message by network system 422, the exit code may enable the user to exit facility 414. Transaction server 410 may also transmit the exit code to gate unit 416 and/or to operator server 412. When the user wishes to exit facility 414, he may enter the code to gate unit 416, for example, by keyboard 4162. Gate unit 416 may identify the exit code and may allow the user to exit facility 414, for example, by opening gate 4164.

Together with the exit code, the user may receive additional information, for example, information regarding the services provided by server 410, advertisement and/or any other suitable information.

If the user is identified as a subscribed user, the payment may be performed by the operator of server 410 or through the operator of network system 422. For example, through an account the user may have at the operator of server 410 or an account the user may have at the operator of network system 422, for example, the cellular phone user account. Third party 418 may pay at least part of the fee, as described in detail above with reference to FIGS. 1-5. For example, third party 418 may communicate facility operator server 412 and/or transaction server 410 for payment of at least part of the fee. The user account may be credited with the amount paid by third party 418.

If the user is not identified by transaction server 410 as a subscribed user, transaction server 410 may communicate to the user, for example, via mobile station 424, for example by an SMS message by network system 422, information enabling fee payment for the facility service, for example, the possibility to pay by payment machines 420. Additionally, the message may include subscribing information, enabling the user to subscribe to services of transaction server 410, for example, by calling an indicated phone number.

In order to receive an exit code, an unsubscribed user may pay the fee by payment machines 420. Payment machine 420 may include a user interface 4202, for example, a keyboard, a pay slot 4204 and an indicator 4206, for example, a display. The user may enter a code which may identify the user with a mobile station, for example, a cellular phone number, to payment machine 420, for example, by interface 4202. Payment machine 420 may communicate the code to transaction server 410, for example, by a communication unit 4208. Payment machine 420 may verify that the entered code is a valid code. If the code should be a cellular phone number, payment machine 420 may verify that the entered code is a cellular phone number. The verification may be performed by payment machine 420 and/or by transaction server 410, which may receive the code from payment machine 420 and communicate to payment machine 420 the verification result.

If the code is approved, payment machine 420 may instruct the user to pay the fee. The instruction may be indicated, for example, by indicator 4206, for example, be displayed on a display or be communicated to the user by any other suitable means, for example, audio instructions. The fee amount may be communicated to payment machine 420 by, for example, transaction server 410 and/or facility operator 412. In case third party 418 has paid at least part of the fee, transaction server 410 and/or facility operator 412 may notify machine 420 and the amount paid by third party 418 may be subtracted from the amount to be paid by the user. Alternatively, the user may be instructed to pay the full amount and the network user account may be credited separately. Payment machine 20 may communicate a payment confirmation to transaction server 410, for example by communication unit 4208, after payment has been received by the machine. Upon payment, machine 420 may communicate to transaction server 410 and/or facility operator 412 that the fee has been paid. Transaction server 410 may communicate, for example, via network system 422, the payment instructions to the user by, for example sending a message to the mobile station identified by the code and/or the cellular phone number entered by the user, with an exit code. For example, if the mobile station identified with the user is mobile station 424, transaction server 410 may send a message, for example, via network system 422, with an exit code to mobile station 424, the exit code may enable the user to exit facility 414. The message may be, for example, an SMS message. Transaction server 10 may also transmit the exit code to gate unit 416. When the user wishes to exit facility 414, he may enter the code to gate unit 416, for example, by keyboard 4162. Gate unit 416 may identify the exit code and may allow the user to exit facility 414, for example, by opening gate 4164.

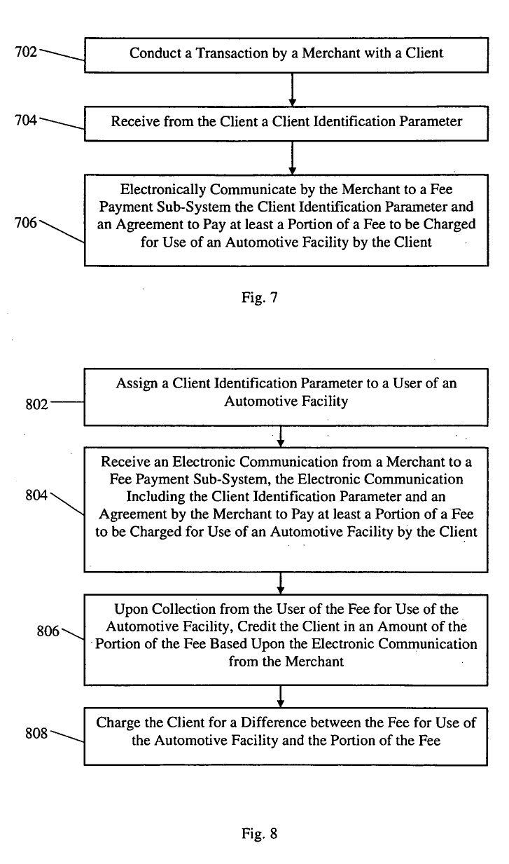

Reference is now made to FIG. 7, which is a flowchart illustrating a method for doing business according to an exemplary embodiment of the present invention. As indicated in block 702, the method may include conducting a transaction by a merchant with a client. As indicated in block 704, the method may include receiving, for example, from the client, a client identification parameter. The client identification parameter may be previously recorded by a fee payment sub-system controlling at least one automotive facility, for example, transaction server 10 or 410. For example, the client identification parameter may be recorded upon entrance of the client to the automotive facility, or upon subscribing of the client to transaction server 10 or 410. The identification parameter may be entered to a gate unit, for example, gate unit 16 or gate unit 416, by the client, for example, upon entering to an automotive facility for a first use of the facility, for example, before the transaction of block 702. The identification parameter may be transmitted to the fee payment sub-system by the gate unit.

As indicated in block 706, the method may include electronically communicating by the merchant to a fee payment sub-system the client identification parameter and an agreement to pay at least a portion of a fee to be charged for use of an automotive facility by the client. The fee payment sub system may credit the client of at least the portion of the fee indicated in the communication, based upon the electronic communication. In one embodiment, the first communicating may comprise instructing the sub-system to credit the client of at least the portion of the fee charged for the first use of the facility. In other embodiment, the first communicating may comprise instructing the sub-system to credit the client of at least the portion of the fee charged for a second use of the facility, upon receiving a notice that a second transaction has been conducted. In this embodiment, the method may further include conducting a second transaction by a merchant with the client. Additionally, the method may include second electronically communicating by the merchant to the fee payment sub-system a notice that a second transaction has been conducted.

Reference is now made to FIG. 8, which is a flowchart illustrating a method for doing business according to an exemplary embodiment of the present invention. As indicated in block 802, the method may include assigning a client identification parameter to a user of an automotive facility. The assigning may be by receiving, for example, from a gate unit of the automotive facility, an identification parameter entered, for example, by a user, for example, upon entering to the automotive facility. As indicated in block 804, the method may include receiving an electric communication from a merchant to a fee payment sub-system, the electronic communication may include the client identification parameter and an agreement by the merchant to pay at least a portion of a fee to be charged for use of an automotive facility by the client. As indicated in block 806, the method may include, for example, upon collection from the user of the fee for use of the automotive facility, crediting the client in an amount of the portion of the fee indicated in the electronic communication based upon the electronic communication from the merchant. As indicated in block 808, the method may include, for example, charging the client for a difference between the fee for use of the automotive facility and the portion of the fee indicated in the electronic communication from the merchant.

After receiving payment instructions which add up to the fee amount, a confirmation may be provided by the fee payment sub-system, that the fee was fully paid. The fee payment sub-system may, for example instruct communication of the confirmation to a mobile station identified with the client. A facility gate unit may receive the confirmation and allow the client to exit from the facility. The facility may receive the confirmation by the user, for example, by entering the confirmation to the gate unit by a user interface.

While certain features of the invention have been illustrated and described herein, many modifications, substitutions, changes, and equivalents will now occur to those of ordinary skill in the art.

What is claimed is:

1. A system for fee payment for automotive facilities, the system comprising:
a facility gate unit having a user interface enabling a user to enter a user code, said facility gate unit enables entrance of said user to a respective automotive facility after entering the code; and
a transaction server to receive from said facility gate unit the code entered by a user and to produce instruction to debit the user for the respective automotive facility service fee based on user identification, said transaction server is further to receive at least one payment instruction, and to provide confirmation that the fee was fully paid,
wherein said facility gate unit enables exit from said respective facility after receiving said confirmation.

2. A system according to claim 1, wherein said at least one payment instruction is to pay at least a portion of said fee payment for automotive facilities.

3. A system according to claim 2, wherein said transaction server provides said confirmation when the portions paid by said at least one payment instruction adds up to the fee amount.

4. A system according to claim 1, wherein said transaction server is to receive said at least one payment instruction from at least one party of a plurality of parties, and to debit each party for the portion of the fee indicated in the corresponding payment instruction.

5. A system according to claim 1, wherein the system further comprising a mobile station identified with said user, said transaction server to instruct communication of said confirmation to said mobile station, and said facility gate to receive said confirmation from the user.

6. A system according to claim 5, wherein said facility gate is to receive said confirmation by the user interface, enabling the user to enter said confirmation.

7. A system according to claim 1, further comprising a payment machine, the machine comprising:
a user interface enabling a user to enter a user identification;
a communication unit to communicate said identification to the transaction server and to receive from the transaction server the fee amount left to be paid by the user,
an indicator to indicate for the user the fee amount left to be paid; and
a payment means to receive payment from the user,

8. A system according to claim 7, wherein said communication unit is further to communicate a payment confirmation to the transaction server after payment is received by the machine.

9. A system according to claim 7, wherein the transaction server provides confirmation that the fee was fully paid after receiving the payment confirmation from payment machine.

10. A system according to claim 9, wherein said confirmation is an exit code provided to said user, via a mobile station identified with the user.

11. A device for fee payment for automotive facilities, the device comprising:
a user interface enabling a user to enter a user identification;
a communication unit to communicate said identification to a transaction server and to receive from the transaction server the fee amount left to be paid by the user,
an indicator to indicate for the user the fee amount left to be paid; and
a payment means to receive payment from the user.

12. A device according to claim 11, wherein said communication unit is further to communicate a payment confirmation to the transaction server after payment is received by the device.

13. A method of doing business comprising:
conducting a first transaction by a merchant with a client;
receiving from said client a client identification parameter, said client identification parameter previously recorded by a fee payment sub-system controlling at least one automotive facility; and
first electronically communicating by said merchant to said fee payment sub-system said client identification parameter and an agreement to pay at least a portion of a fee to be charged for use of an automotive facility controlled by said fee payment sub-system by said client, wherein said fee payment sub-system is to credit said client based upon said electronic communication of at least said portion of said fee.

14. A method according to claim 13, wherein said identification parameter is entered to a gate unit by the client upon entering to a automotive facility for a first use of the facility before said first transaction and transmitted to the fee payment sub-system by the gate unit.

15. A method according to claim 14, wherein said first electronically communicating comprises instructing said sub-system to credit said client of at least said portion of a fee charged for said first use.

16. A method according to claim 14, wherein said first electronically communicating comprises instructing said sub-system to credit said client of at least said portion of a fee charged for a second use upon receiving a notice that a second transaction has been conducted, the method further comprising:
conducting a second transaction by said merchant with said client; and
second electronically communicating by said merchant to said fee payment sub-system a notice that a second transaction has been conducted.

17. A method of doing business comprising:
assigning a client identification parameter to a user of an automotive facility;
receiving an electronic communication from a merchant to a fee payment sub-system, said electronic communication including said client identification parameter and an instruction to debit said merchant for at least a portion of a fee to be charged for use of said automotive facility by said client; and
upon collection from said user of said fee for use of said automotive facility, crediting said client in an amount of said portion of the fee based upon said electronic communication from said merchant.

18. A method of doing business as in claim 17, further comprising charging said client for a difference between said fee for use of said automotive facility and said portion of said fee.

19. A method according to claim 17, wherein said assigning is by receiving from a gate unit of said automotive facility an identification parameter entered to said gate unit by the client upon entering to the automotive facility.

20. A method according to claim 17, further comprising:
providing confirmation that the fee was fully paid after receiving payment instructions which adds up to the fee amount; and
enabling the client to exit from said facility after receiving said confirmation by a facility gate unit.

21. A method according to claim 20, further comprising:
instructing communication of said confirmation to a mobile station identified with said client; and
receiving said confirmation from the user by said facility gate.
